(19) United States
(12) Patent Application Publication
(10) Pub. No.: US 2017/0052669 A1
(43) Pub. Date: Feb. 23, 2017

(54) NAVIGATION AND VISUALIZATION OF MULTI-DIMENSIONAL DATA

(71) Applicant: SAP SE, Walldorf (DE)

(72) Inventor: Tao LI, Berlin (DE)

(21) Appl. No.: 14/830,748

(22) Filed: Aug. 20, 2015

(51) Int. Cl. G06F 3/0486; G06F 3/0482; G06F 3/0484; G06F 17/30

(52) U.S. Cl. CPC G06F 3/0486; G06F 17/30592; G06F 3/0482; G06F 3/04842

(57) ABSTRACT

Disclosed herein are technologies for navigating and visualizing multi-dimensional data. In accordance with one aspect, a data set containing multi-dimensional data is provided. An edit control that displays a list of dimensions of the data set for user selection upon being activated is provided on a visualization. In response to receiving user selection of one or more dimensions from the list of dimensions, a graphical representation of the data set is presented. The graphical representation contains an overview visualization of the data set in accordance with all the user selected dimensions. The graphical representation includes data elements and data values of the data set arranged in accordance with the selected dimensions in a first drill down order. In some implementations, the first drill down order is associated to the positions of the dimensions on the graphical representation, where a drag and drop operation of a dimension to a different position changes the drill down order of the dimensions to a second drill down order.

### TECHNICAL FIELD

The present disclosure relates generally to a framework for navigating and visualizing multi-dimensional data.

### BACKGROUND

Data analytics is an important facet of modern day enterprise as operations increasingly become data-driven. Large volume of data are collected, organized and analyzed to draw valuable and useful insights and information from the analysis of the data. For example, data with multiple dimensions may be analyzed according to various dimensions or combination of dimensions to determine inter alia, performance, patterns, and progress of a particular operational activity from various viewpoints. As the dimensions and volume of data increases, it is desirable to provide users with an efficient tool for analyzing and visualizing multi-dimensional data.

### SUMMARY

A technology for navigating and visualizing multi-dimensional data is described herein. In accordance with one aspect, a data set containing multi-dimensional data is provided. An edit control that displays a list of dimensions of the data set for user selection upon being activated is provided on a visualization of the data set. In response to receiving user selection of one or more dimensions from the list of dimensions, a graphical representation of the data set is presented. The graphical representation contains an overview visualization of the data set in accordance with all the user selected dimensions. The graphical representation includes data elements and data values of the data set arranged in accordance with the selected dimensions in a first drill down order. In some implementations, the first drill down order is associated to the positions of the dimensions on the graphical representation, where a drag and drop operation of a dimension to a different position changes the drill down order of the dimensions to a second drill down order on an updated graphical representation.

With these and other advantages and features that will become hereinafter apparent, further information may be obtained by reference to the following detailed description and appended claims, and to the figures attached hereto.

### BRIEF DESCRIPTION OF THE DRAWINGS

Some embodiments are illustrated in the accompanying figures, in which like reference numerals designate like parts, and wherein:

FIG. 1 is a block diagram illustrating an exemplary system;

FIG. 2 shows a block diagram of an exemplary architecture of a navigation and visualization system;

FIG. 3 shows a simplified exemplary data set;

FIG. 4 shows an exemplary graphical representation of the data set;

FIG. 5 is a block diagram illustrating an exemplary process of navigating and visualizing a multi-dimensional data set;

FIG. 6 shows an exemplary list of user selectable dimensions;

FIG. 7 shows an exemplary graphical representation based on user selected dimensions;

FIG. 8 illustrates an exemplary drag and drop operation to change the drill down of a visualization of the data set;

FIG. 9 illustrates an exemplary graphical representation in response to the drag and drop operation;

FIGS. 10-11 show exemplary graphical representations which zooms in on an element of the data set; and

FIGS. 12-13 show other exemplary graphical representations of another data set.

### DETAILED DESCRIPTION

In the following description, for purposes of explanation, specific numbers, materials and configurations are set forth in order to provide a thorough understanding of the present frameworks and methods and in order to meet statutory written description, enablement, and best-mode requirements. However, it will be apparent to one skilled in the art that the present frameworks and methods may be practiced without the specific exemplary details. In other instances, well-known features are omitted or simplified to clarify the description of the exemplary implementations of the present framework and methods, and to thereby better explain the present framework and methods. Furthermore, for ease of understanding, certain method steps are delineated as separate steps; however, these separately delineated steps should not be construed as necessarily order dependent in their performance.

A framework or application for navigating and visualizing multi-dimensional data is described herein. Dimensions, as used herein, generally refer to categories of elements of data points in a data set. One aspect of the present framework allows a user the flexibility to customize visualizations or graphical representations of multi-dimensional data according to his or her desired dimensions and drill down in a single view.

Conventional visualization of multi-dimensional data employs recursive drop-down lists containing the dimensions of the data set to navigate through several levels of dimensions in order to arrive at the visualization or view of the data set with the selected combination of dimensions in the desired drill down. Unlike conventional systems which may be tedious and complicated as the number of dimensions increase, the present framework allows users the flexibility to navigate the data set and perform multi-dimensional analysis by selecting all the desired dimensions from a list in a single step without the need to recursively select from a drop down list. Such selection is enabled by providing the user with a configure or edit control button on the display, which upon being selected, provides the list containing all the dimensions of the data set.

The edit control button allows a user to configure or choose the desired dimensions in a single step for visualizing the desired information of the data set in a single view. The control button, for example, may be a button labeled with the text “configure” or “edit”. In other implementations, the control button may be presented by other visual representations such as a plus sign icon indicating the function to change the dimensions or combination of dimensions of the data set to be visualized. Other types of control button for choosing the dimensions may also be useful. The framework dynamically presents an updated visualization of the data set in accordance with the user selected dimensions in a single view.

Additionally, the framework allows the user to easily change the visualization of the data set with the selected dimensions to obtain various drill down of data being displayed for analysis. In some implementations, the user may easily change the drill down order of the displayed data by performing drag and drop operations. The framework further allows the user to zoom in on portions of the visualization to obtain detailed information with a single click of a portion of interest.

The visualization may be dynamically generated as user input is received via a user interface. The data navigation and visualization framework may be used, for example, to analyze a budgeting process from various aspects to track the performance of a project. For example, data analysis may be performed based on departmental dimension, cost element dimension, head or project dimension, sub-project dimension. The allocated budget may further be drilled-down across a number of levels of dimensions such as, for example, from a primary dimension (e.g., project) to lower level dimensions (e.g., employees and cost element) to provide a more detailed and useful information such as when different elements and combination of elements are taken into consideration in an evaluation. The framework allows the user to explore and quickly analyze the data set to obtain useful and meaningful insights in a flexible and user friendly manner.

The framework described herein may be implemented as a method, computer-controlled apparatus, a computer process, a computing system, or as an article of manufacture such as a computer-usable medium. These and various other features will be apparent from the following description.

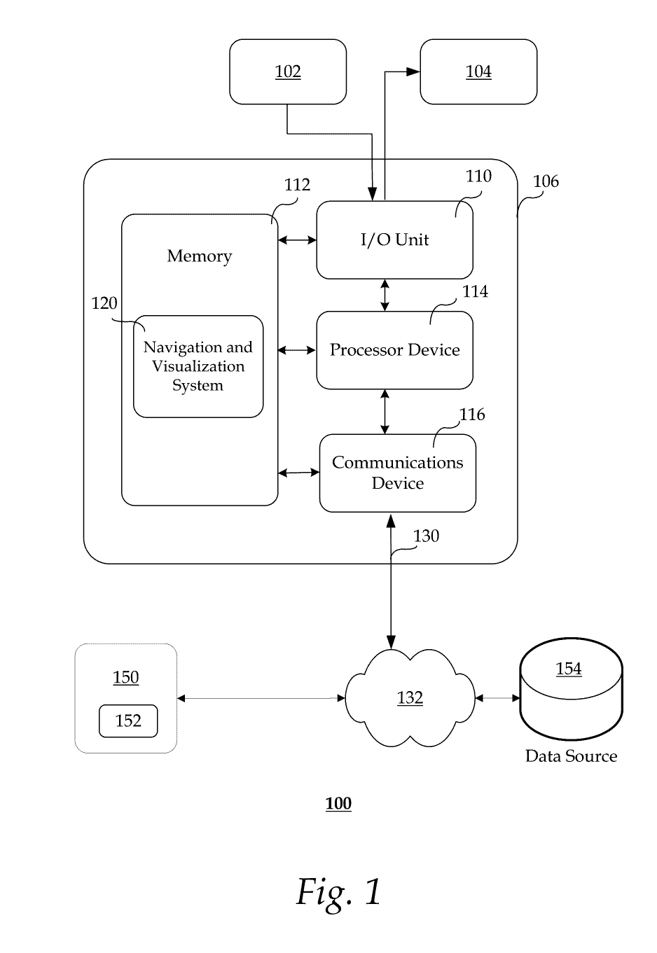

FIG. 1 shows a block diagram illustrating an exemplary system 100 that may be used to implement the framework described herein. System 100 includes a computer system 106 communicatively coupled to an input device 102 (e.g., keyboard, touchpad, microphone, camera, etc.) and an output device 104 (e.g., display device, monitor, printer, speaker, etc.). Computer system 106 may include a communications device 116 (e.g., a modem, wireless network adapter, etc.) for exchanging data with a network 132 using a communications link 130 (e.g., telephone line, wireless or wired network link, cable network link, etc.). The network may be a local area network (LAN) or a wide area network (WAN). The computer system 106 may be communicatively coupled to one or more other computer systems 150 via the network. For example, the computer system 106 may act as a server and operate in a networked environment using logical connections to one or more client computers 150.

Client computers 150 may include components similar to the computer system 106, and may be in the form of a desktop computer, mobile device, tablet computer, communication device, browser-based device, etc. A user at the client computer 150 may interact with a user interface component 152 to communicate with the computer system 106. For example, the interface may be used to access various applications in the computer system 106. The user interface may be interactive to dynamically present visualizations of the data set. The user interface may also serve other purposes. In one implementation, the user interface component comprises a graphical user interface (GUI). A GUI may provide an efficient and user-friendly manner of presenting information or communicating with the system 106. Other types of user interfaces may also be useful.

The computer system 106 may be communicatively coupled to one or more data sources 154. Data sources may be, for example, any database (e.g., relational database, in-memory database, etc.), an entity (e.g., set of related records), or data sets or data files included in a database. Alternatively, the database may be stored in a memory device of computer system 106. In some implementations, the data sets may be related to or generated by one or more software applications residing in the computer system 106 or obtained from another source. A data set may be from a stand-alone file or a set of data embedded in one or more files, which may be local or remote. Exemplary data set may include, but are not limited to, budget planning data, project development data, as well as other types of data. In one implementation, the data source includes data sets with multiple dimensions. A data set, for example, may be organized based on dimensions, as will be described in more details in the following description.

It should be appreciated that the different components and sub-components of the computer system 106 may be located on different machines or systems. It should further be appreciated that the components of the client computer 150 may also be located on the computer system 106, or vice versa.

Computer system 106 includes a processor device or central processing unit (CPU) 114, an input/output (I/O) unit 110, and a memory module 112. Other support circuits, such as a cache, a power supply, clock circuits and a communications bus, may also be included in computer system 106. In addition, any of the foregoing may be supplemented by, or incorporated in, application-specific integrated circuits. Examples of computer system 106 include a smart device (e.g., smart phone), a handheld device, a mobile device, a personal digital assistance (PDA), a workstation, a server, a portable laptop computer, another portable device, a mini-computer, a mainframe computer, a storage system, a dedicated digital appliance, a device, a component, other equipment, or some combination of these capable of responding to and executing instructions in a defined manner.

Memory module 112 may be any form of non-transitory computer-readable media, including, but not limited to, static random access memory (SRAM), Erasable Programmable Read-Only Memory (EPROM), Electrically Erasable Programmable Read-Only Memory (EEPROM), flash memory devices, magnetic disks, internal hard disks, removable disks, magneto-optical disks, Compact Disc Read-Only Memory (CD-ROM), any other volatile or non-volatile memory, or a combination thereof.

Memory module 112 serves to store machine-executable instructions, data, and various programs, such as a navigation and visualization system 120 for implementing the techniques described herein, all of which may be processed by processor device 114. As such, the computer system 106 is a general-purpose computer system that becomes a specific-purpose computer system when executing the machine-executable instructions. Alternatively, the various techniques described herein may be implemented as part of a software product. Each computer program may be implemented in a high-level procedural or object-oriented programming language (e.g., C, C++, Java, etc.), or in assembly or machine language if desired. The language may be a compiled or interpreted language. The machine-executable instructions are not intended to be limited to any particular programming language and implementation thereof. It will be appreciated that a variety of programming languages and coding thereof may be used to implement the teachings of the disclosure contained herein.

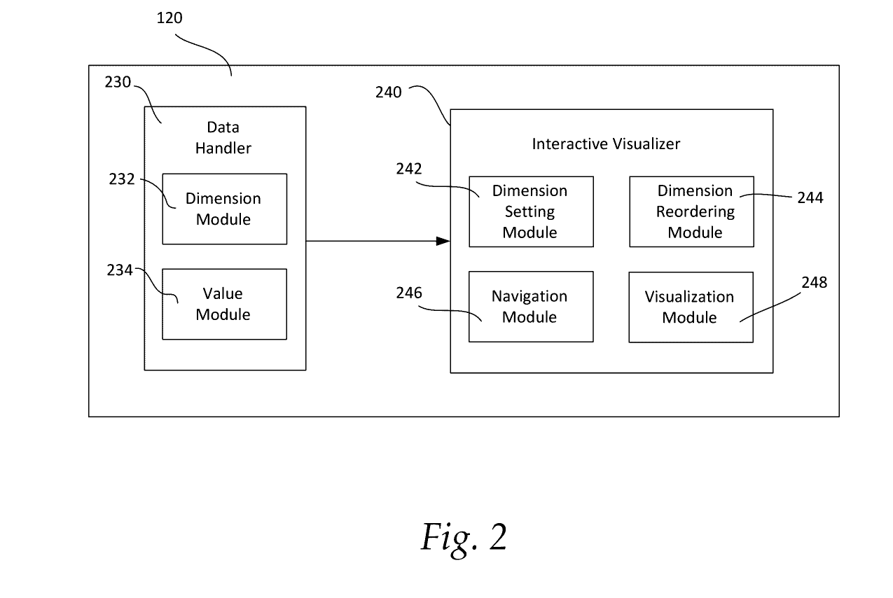

FIG. 2 shows a block diagram of an exemplary architecture of the navigation and visualization system 120. As shown, the navigation and visualization system includes a data handler 230 and an interactive visualizer 240. The navigation and visualization system may also include other components.

The data handler 230 retrieves data sets from the data source and stores the data for use by the interactive visualizer 240. The retrieved data, for example, is a multi-dimensional data. In some implementations, the multi-dimensional data may be a table containing data points and its respective dimensional elements and values. Providing the multi-dimensional data in other formats may also be useful.

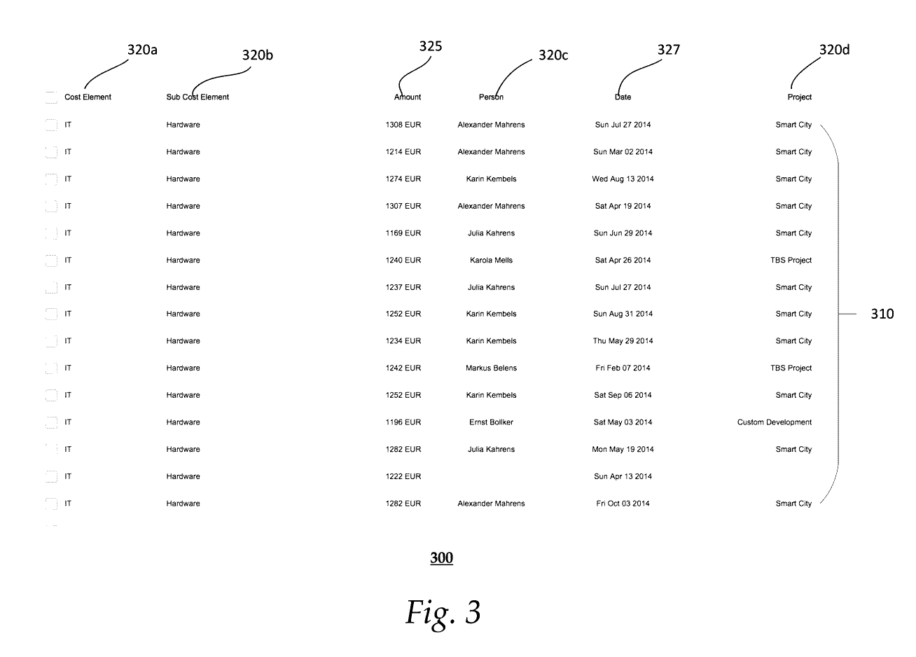

FIG. 3 shows a simplified exemplary data set. The data set, for example, includes data for an enterprise budgeting process retrieved from the data source. The data, in one implementation, may be structured data. For example, the data set includes data organized in one or more tables. As shown, data set table 300 may have a tabular data structure, each row identifying a particular data point 310 and each column providing elements of each data point. For example, the columns of each data point may contain a data point value 325 and elements which correspond to dimensions 320a-d. For example, the data point value 325 may be the amount of the expenses allocated or committed in the budgeting process while the dimensions may include cost element 320a, sub cost element 320b, person budget is allocated or committed to 320c, and project 320d. The dimensions, for example, represent the collective attributes of the elements in its respective column. The data value of each data point is described by the combination of its respective dimensional elements. Providing other dimensions and respective elements in the data set may also be useful. For example, the column may also include a date 327 dimension.

In some implementation, the data handler includes data modules for handling multi-dimensional data. Referring back to FIG. 2, the data handler, in one implementation, includes a dimension module 232 and a value module 234. The dimension module 232 serves to manage and coordinate the dimensional elements of each data point or entry of the stored data set for visualization while the value module 234 determines the value of the elements of each data point and aggregate values based on combination of the dimensional elements.

As for the interactive visualizer 240, it includes various modules for interactively visualizing the data from the data handler based on user input. In some implementations, the interactive visualizer 240 dynamically customizes or personalizes graphical representations of the retrieved data in response to input from a user via the user interface. In one implementation, the interactive visualizer includes a dimension setting module 242, a dimension reordering module 244, a navigation module 246 and a visualization module 248. Providing the interactive visualizer with other modules may also be useful.

The dimension setting module 242 allows a user to add or remove dimensions to the displayed graphical representation of the data set. In one implementation, the dimension setting module provides configure control button that enables a user to customize the graphical representation of the data set according to the dimensions of his or her preference. The configure control button presents a list of dimensions of the data set upon being activated. In response to receiving user selection of one or more dimensions from the list of dimensions, the interactive visualizer presents an updated graphical representation of the data set in accordance with the selected dimensions. The graphical representation comprises an overview visualization of the data set in accordance with the user selected dimensions. Enabling the user to customize the graphical representation by adding or removing dimensions allows for flexibility to perform data analysis with a desired number of dimensions, combination of dimensions, and drill down across various levels of the dimensions.

The dimension reordering module 244 enables drill-down control over the visualization (or graphical representation) that is being displayed. In one implementation, the dimension reordering module changes the drill down of the data that is being displayed in response to receiving user input. In some implementations, the dimension reordering module determines the drill down of the displayed data based on its position on the visualization. For example, the drill down order is associated to positions of the dimensions on the graphical representation. Upon receiving user input that changes the position of a dimension on a current graphical representation, the dimension reordering module reorders the hierarchical level of the dimensions and drill down of the data. The dimension reordering module then causes the visualizer to present an updated graphical representation based on the new drill down order of the data in accordance with the user selected dimensions. The user input, in one implementation, may be a drag and drop operation of a dimension to a position of another dimension that effectively changes its position and arrangement of the corresponding dimensional elements on an updated visualization.

The navigation module 246 serves to enable a zoom in and zoom out function for users to focus in on detailed information, for example, of a particular element of interest of the data set that is being displayed. As for the visualization module 248, it includes a set of function modules or programs designed to generate graphical representations of data set. The graphical representations, for example, may include a chart containing chart portions or chart segments that represent various details and data types of the data set. In some implementations, the visualization module configures the visualization of the chart for representing the data set. For example, the chart may be segmented into portions to represent the different types of values in the chart. The visualization module, for example, determines the chart area and its configuration which is to be presented on the visualization.

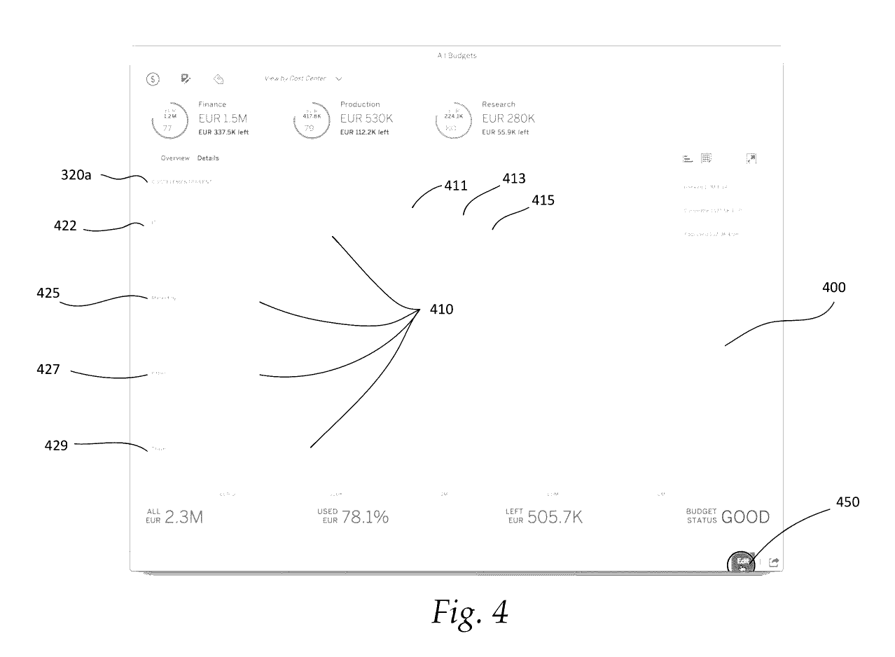

FIG. 4 shows an exemplary view of a graphical representation 400 of the data set 300. The graphical representation 400 may be presented via, for example, the user interface component 152. The graphical representation in this example is presented as a bar chart which summarizes the data point values in accordance with one or more dimensions presented on the graphical representation. The displayed dimension or dimensions may be arranged in one or more columns with its corresponding data point elements. It should be appreciated that other types of charts or representations of the data set may also be used.

The graphical representation 400 as depicted may be a default view of the data set. The default view, for example, displays the data point values of the data set in accordance with a dimension which is automatically preselected by the visualization module. The preselected dimension, for example, may be from the first column of dimensional elements organized in the data set table 300. The graphical representation in this example is presented as a bar chart 410 which summarizes the data point values based on the cost element 320a dimension. The cost element 320a dimension includes elements such as IT 422, Marketing 425, Other 427, and Travel 429. Other types of dimensional elements may also be useful. The bar chart as depicted may be segmented into portions 411, 413 and 415 to represent the different types of values in the summary bar chart. Providing other default views and other types of charts may also be useful.

As illustrated, the graphical representation includes a configure or edit control button 450. The configure control button 450 enables a user to customize the graphical representation according to the dimensions of his or her preference. For example, the user may customize the graphical representation of the data set by adding or removing dimensions in which the graphical representation of the data set is based on.

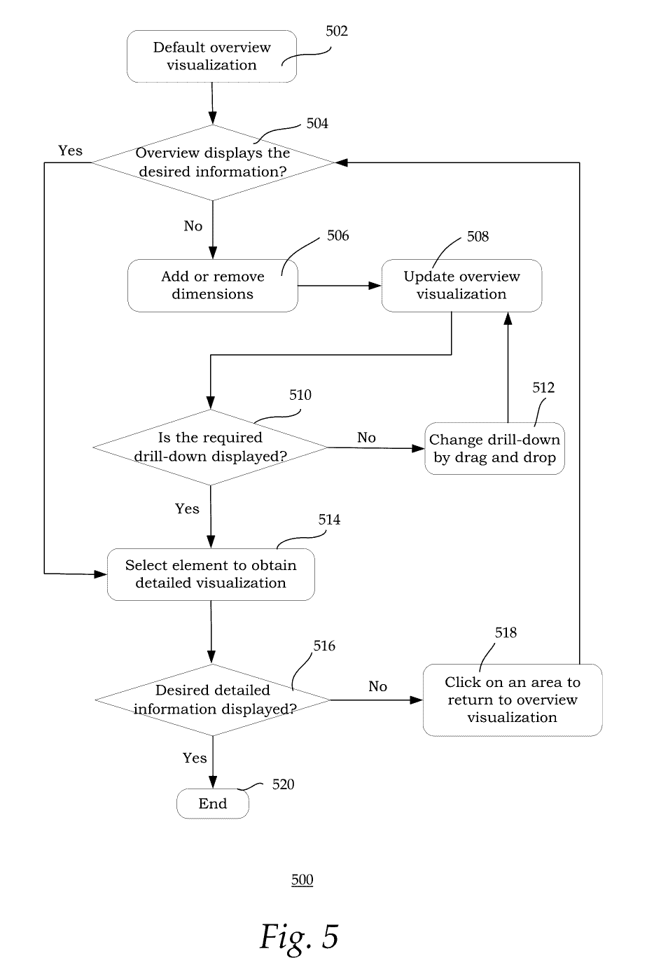

FIG. 5 is a block diagram illustrating an exemplary process 500 of navigating and visualizing a multi-dimensional data set. The computer system 106 of FIGS. 1 and 2 may be configured by computer program code to implement some or all acts of the process 500. While process flow 500 describes a series of acts that are performed in sequence, it is to be understood that process 500 is not limited by the order of the sequence. For instance, some acts may occur in a different order than that described. In addition, an act may occur concurrently with another act. In some instances, not all acts may be performed.

At 502, a graphical representation with a default overview visualization of a data set is displayed on a user interface. For example, a default overview visualization of the data set 300 is displayed. The default overview visualization may be as described above with reference to FIG. 4. At 504, a user determines whether the overview visualization displays the desired information. If the overview displays the desired information, the process proceeds to step 514. If the desired information is not displayed, at 506, one or more dimensions may be added or removed from the displayed graphical representation of the data set. A configure control button as described may be selected for adding or removing dimensions.

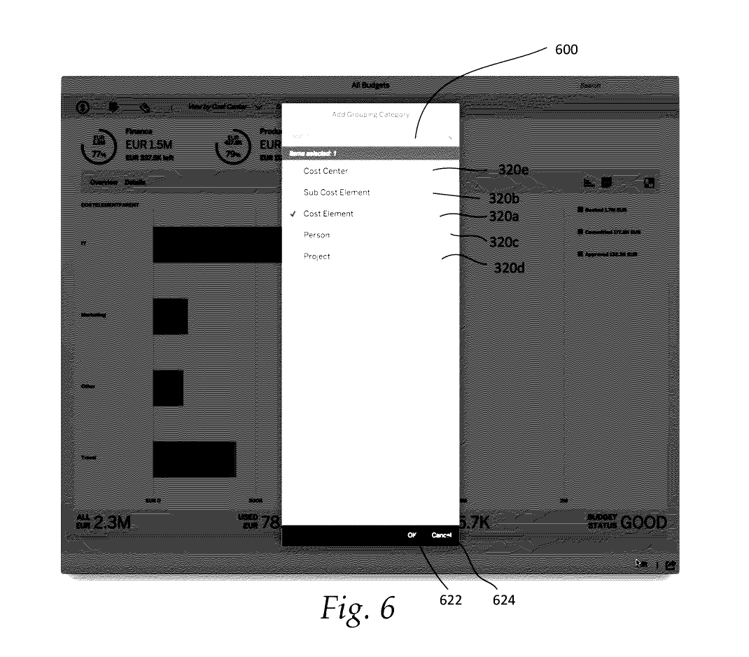

In one implementation, the configure control button presents a pop-up containing a list of dimensions of the data set upon being activated (e.g., clicking, selecting). FIG. 6 shows an exemplary list 600 of dimensions of the data set. The list may be presented in response to user selection of the configure control button. The list includes all the dimensions which are available in the exemplary data set 300. As depicted in FIG. 6, the dimensions available in the list include cost center 320e (not shown in the simplified data set table 300 in FIG. 3), sub cost element 320b, cost element 320a, person 320c and project 320d. The user may select the desired dimension for inclusion into his or her analysis of the data set by checking on the box icons of the respective dimensions. For example, the user may add dimensions 320c and 320d by checking the respective box icons. Alternatively, the user may remove the pre-selected dimension cost element 320a from the previous visualization. Buttons 622 and 624 may be provided to confirm the selection or to cancel any changes.

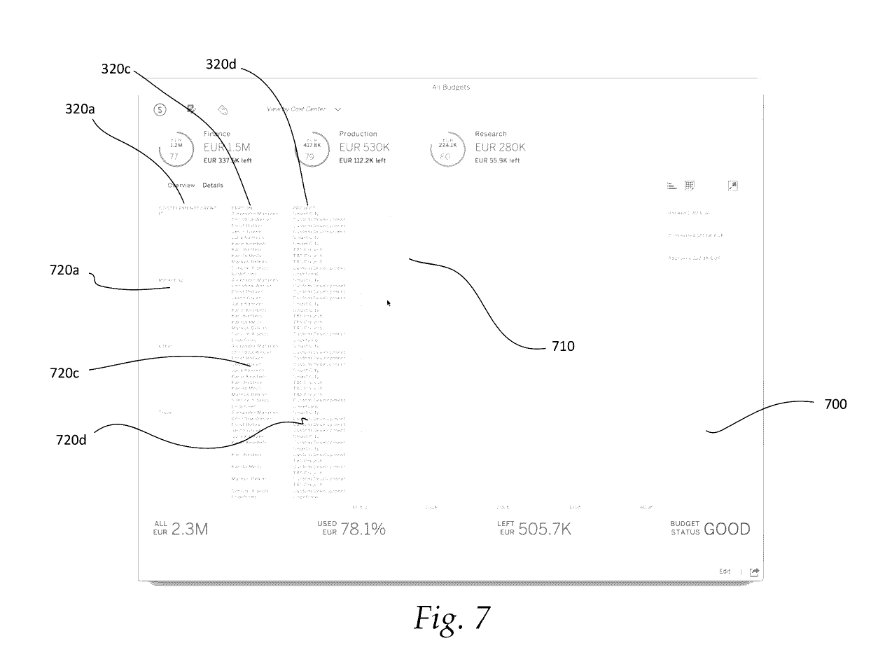

Selection of the dimensions from the list invokes the dimension setting module to organize and arrange the elements and values of the data points in accordance with the selected dimensions for visualization by the visualizer. At 508, the visualizer updates the graphical representation to present an updated overview visualization of the data set in accordance with the selected dimensions. All the selected dimensions and its corresponding elements and data values are presented in a single view or display of the graphical representation. FIG. 7 shows an exemplary graphical representation 700 of the data set 300 presented on the user interface in response to receiving the user selected dimensions. The dimensions 320a, 320c and 320d are displayed in the updated graphical representation. As shown, the user selection triggers a refresh of the graphical representation to display a new chart 710 representing the data values in accordance with the corresponding elements 720a, 720c and 720d of the selected dimensions in a single view.

As illustrated in FIGS. 4-7, the configure control button provides the user the flexibility to customize the dimensions being displayed in a single view based on the user selected dimensions from a single list containing the available dimensions of the data set. For example, the graphical representation presents an overview visualization of the data set in response to a single selection of the desired dimensions.

Returning to FIG. 5, at 510, a user may determine if the visualization displays the data with the desired drill down. If the visualization displays the data with the desired drill down, the process proceeds to step 514. If the data is not visualized with the desired drill down, at 512, the drill down may be changed by a drag and drop operation. The drag and drop operation may be performed by a user to change the drill down of the graphical representation of the data set with the selected dimensions.

In some implementations, the dimension reordering module arranges the data set in a first drill down order of the selected dimensions. For example, the first drill down order includes an arrangement of the data set with the cost element 320a dimension as the primary or parent dimension of the data set and the person 320c and project 320d dimensions as child or lower level dimensions of the parent dimension. The bar chart representing data values of the data set are organized or summarized based on the drill down order of the dimensions. This allows the user to analyze the values of the data set, for example, based on the relationships of the elements according to a particular drill down or hierarchical level of the dimensions.

As illustrated in FIG. 7, the drill down order may be based on the position of the dimensions and its corresponding data elements arranged on the graphical representation. For example, the cost element 320a dimension may be positioned in a first column of the graphical representation to represent the primary dimension of the drill down of the data set while the person 320c and project 320d dimensions may be positioned in second and third columns of the graphical representation to represent the lower dimensions of the drill down of the data set. Providing other arrangements to represent the drill down order may also be useful.

The first drill down order, in one implementation, may be predefined by the interactive visualizer. The interactive visualizer, for example, may determine the parent and child dimensions of the drill down order from the data set table. For example, the dimension listed in the first column of the data set table may be automatically chosen as the parent dimension for the graphical representation. In the exemplary data set table 300, the cost element 320a dimension is automatically identified as the parent dimension by the interactive visualizer as it is in the first column of the data set table. The remaining person 320c and project 320d dimensions are identified as the child dimensions. Providing other drill down order and arrangement of the data set of the selected dimensions by the interactive visualizer may also be useful.

The user may re-arrange the drill down order of the displayed data set by, for instance, performing a drag and drop operation to change the drill down flow of the graphical representation of the data set in accordance with the selected dimensions. The dimension reordering module enables the user to interactively change the drill down order in response to receiving user input. For example, the user may perform a drag and drop operation of the dimensions via the user interface to change the position of the dimensions.

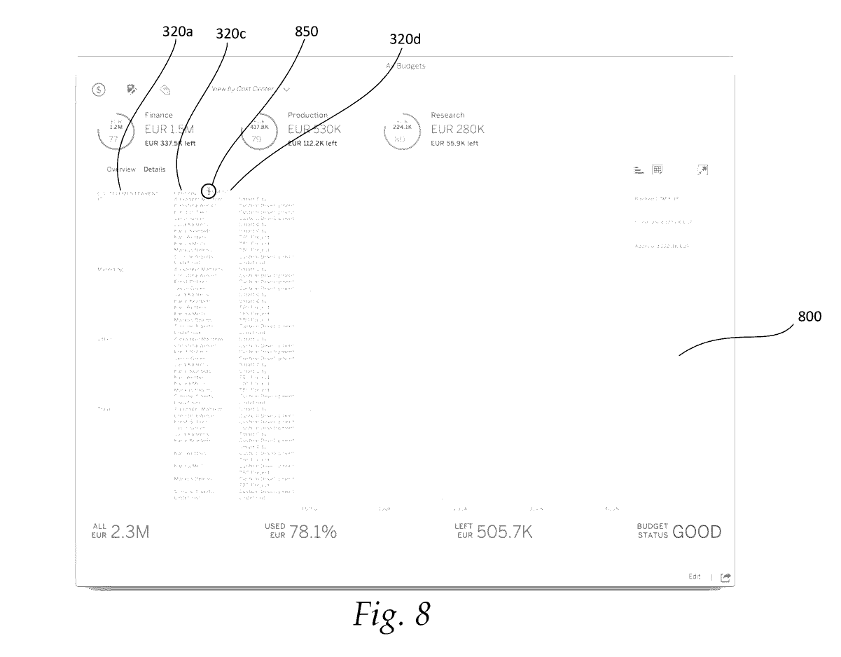

FIG. 8 illustrates an exemplary drag and drop operation on the graphical representation 800 to change the drill down of the visualization of the data set. For example, the user may change the first drill down order with the project 320d dimension as the child dimension to a second drill down order with the project 320d dimension as the parent dimension. As illustrated, a drag and drop operation 850 is performed on the project 320d dimension. The project 320d dimension may be dragged and dropped from the third column to the first column of the graphical representation. Dragging and dropping the dimension project 320d to the first column changes its position on the user interface to replace a previous dimension in that position as the parent dimension. The cost element 320a and person 320c dimensions are automatically moved or displaced to the second and third columns from the first and second columns respectively. Returning to FIG. 5, at 508, the dimension reordering module updates the graphical representation with the cost element 320a and person 320c dimensions being the child dimensions. The drag and drop operation effectively changes the drill down order and arrangement of the data set to a second drill down order. The bar chart representing the aggregated data point values of the displayed dimensional elements are also updated in accordance with the second drill down order.

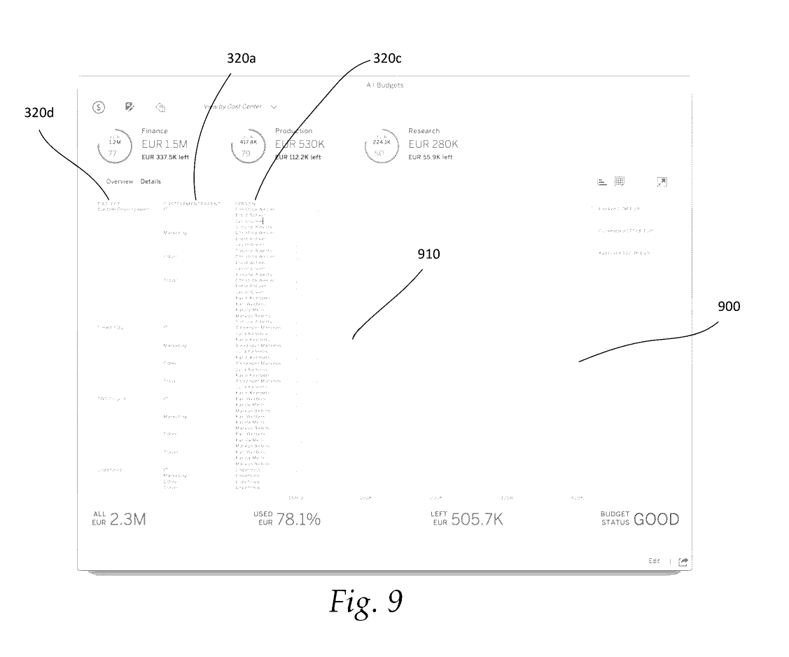

FIG. 9 illustrates an exemplary view of a graphical representation 900 of the data set 300 after the drag and drop operation. As shown, the bar chart 910 representing the data values is updated in response to the change of the drill down order. The data values are recalculated and presented based on the second drill down order with the arrangement of the data set being in accordance with the project 320d as the parent dimension and the cost element 320a and person 320c as the child dimensions. The framework advantageously enables the same data set with the same user selected dimensions to be graphically presented in a different drill down flow. This allows the user to easily analyze the same data set in a different perspective by simply swapping the position of the dimensions on the user interface. Further, the framework provides an intuitive and clear route of the drill down flow of the presented data. The user may continuously perform drag and drop operations to obtain the desired drill down of the displayed data in accordance with the selected dimensions.

Returning to FIG. 5, at 514, a zoom in and zoom out function may be performed to obtain detailed visualization. In one implementation, the navigation module allows the user to zoom in on a portion of the graphical representation. The navigation module may be configured to focus on the portion of interest in response to a simple selection of the portion by the user. For example, the user may be able to analyze a particular element of a dimension on a displayed graphical representation in closer detail by selecting the element. In response to the user selecting a particular element, the graphical representation may be refreshed to display a different graphical representation that zooms in on the element and its related elements and corresponding bar chart.

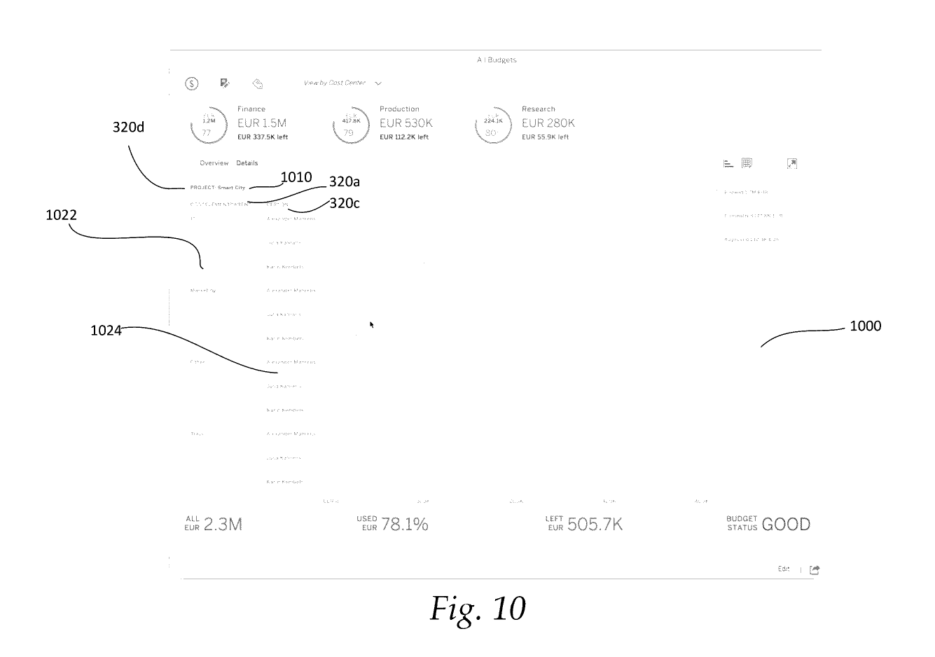

FIG. 10 shows an exemplary graphical representation 1000 which zooms in on the smart city 1010 element of the project 320d dimension in response to the user selecting the smart city element from the previous graphical representation 900. The corresponding elements 1022 and 1024 of the child dimensions (cost element 320a and person 320c) together with the bar chart representing the data values from the previous graphical representation 900 are enlarged based on the selected smart city 1010 element of the parent dimension project 320d. This allows the user to directly dive into a more detailed visualization of the information with just one click or selection of an element. As shown, the zoom in causes the other elements of the same project 320d dimension as the smart city element 1010 to be removed from graphical representation.

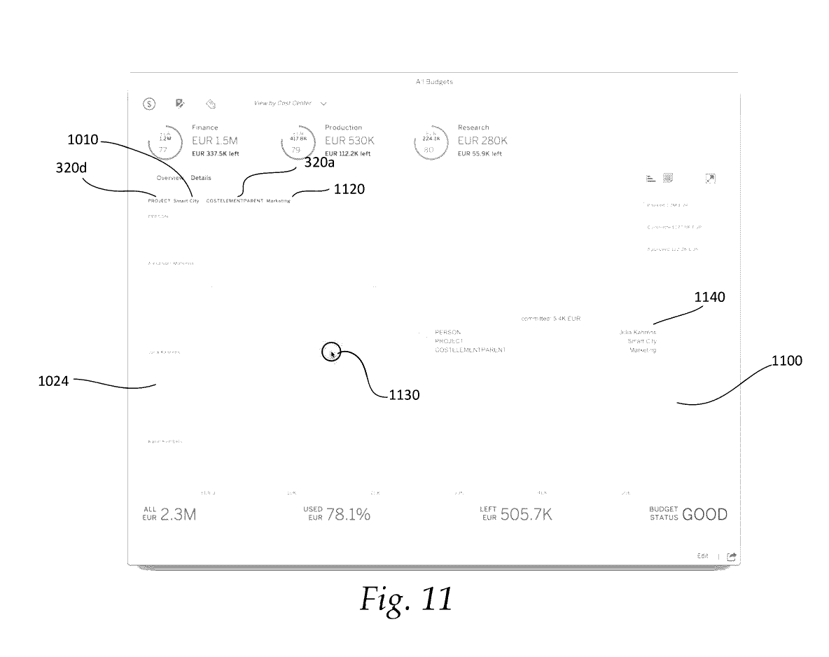

FIG. 11 shows an exemplary graphical representation 1100 which further zooms in on the marketing 1120 element of the cost element 320a dimension in response to the user selecting the marketing element from the previous graphical representation 1000. Similarly, the graphical representation 1100 enlarges the related or corresponding elements 1024 of the child dimension person 320c together with the bar chart representing the data values which is dependent from the elements smart city 1010 and marketing 1120 of the parent dimension project 320 and child dimension cost element 320a. This enables the user to navigate further into the details of the data set of the second drill down order with a simple click or selection of an element. As shown, the zoom in further causes other elements of the same cost element 320a dimension as the marketing element 1120 to be removed from view.

Additionally, the bar chart may be selectable to display detailed information represented by the bar chart. For example, in response to user selection 1130 of a portion or area of the bar chart, the visualization module displays a pop up box 1140 containing information represented by the selected portion of the bar chart. At 516, if the desired detailed information is displayed, the process for navigating and visualizing the data set ends at 520. The user may start a new process for navigating and visualizing the data set as desired. If the desired detailed information is not displayed, at 518, the user may click on an area of the visualization to return to the overview visualization. In other words, the user may zoom out or return to the graphical representation with the overview visualization of the data set which displays all the elements of the selected dimensions and its corresponding chart, for example, by clicking on a blank area of the graphical representation 1100. The process then returns to step 510.

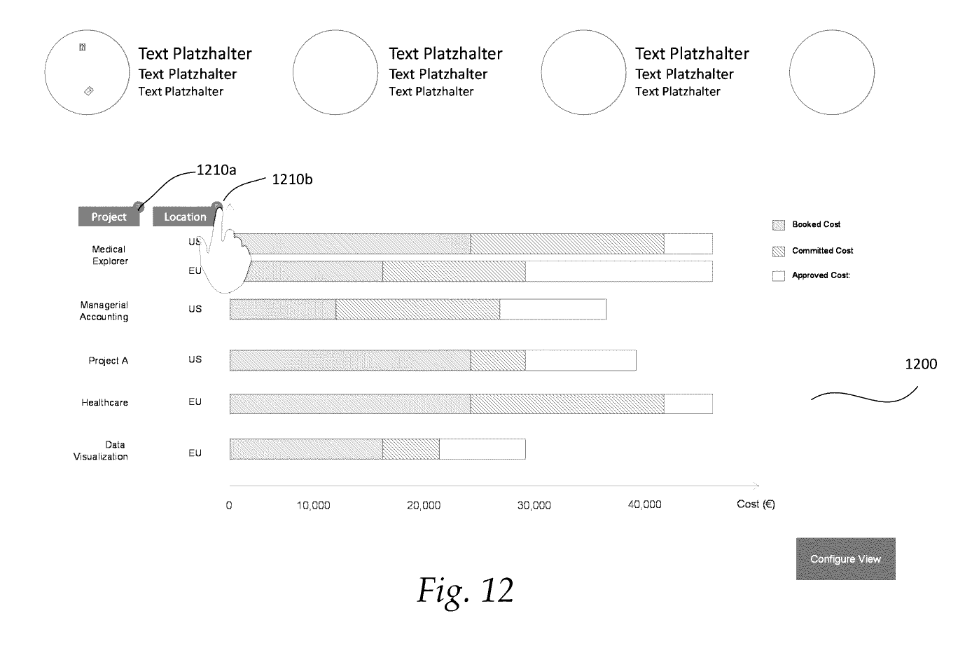

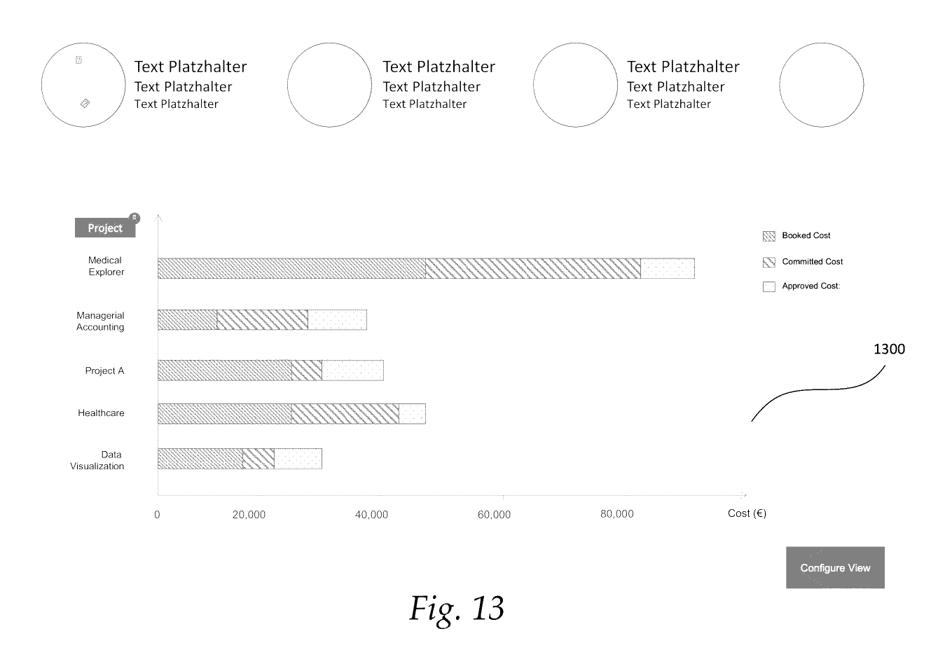

In some implementations, the user may remove a dimension from the graphical representation by selecting a removal icon associated to a particular dimension. FIG. 12 shows another exemplary graphical representation 1200 of a different data set. As shown, the dimensions may also include icons 1210a-1210b for convenient and easy removal of a dimension from the analysis. For example, a user selection of the icon 1210a removes the location dimension and its corresponding elements, leaving the project dimension on an updated graphical representation 1300 as shown in FIG. 13. The bar chart representing the data values are refreshed to reflect data values based only on the elements of the project dimension.

Although the one or more above-described implementations have been described in language specific to structural features and/or methodological steps, it is to be understood that other implementations may be practiced without the specific features or steps described. Rather, the specific features and steps are disclosed as preferred forms of one or more implementations.

1. A system for navigating and visualizing multi-dimensional data, comprising:
a non-transitory memory device for storing computer readable program code; and
a processor device in communication with the memory device, the processor device being operative with the computer readable program code to perform steps including
providing a data set comprising multi-dimensional data;
providing an edit control on a visualization that displays a list dimensions of the data set for user selection upon being activated;
in response to receiving user selection of one or more dimensions from the list of dimensions, presenting a graphical representation of the data set, the graphical representation comprises an overview visualization of the data set in accordance with the user selected dimensions; and
wherein the graphical representation comprises data elements and data values arranged in accordance with the selected dimensions in a first drill down order.

2. The system of claim 1 wherein the first drill down order is associated to positions of the dimensions on the graphical representation, wherein a drag and drop operation of a dimension to a different position changes the drill down order of the dimensions to a second drill down order, the graphical representation changes to display the data elements and the data values in accordance with the second drill down order.

3. The system of claim 2 wherein:
the first drill down order comprises a first dimension presented in a first position as a parent dimension and a second dimension presented in a second position as a child dimension of the parent dimension; and
the drag and drop operation comprises dragging and dropping the second dimension from the second position to the first position to change the drill down order to the second drill down order, resulting the second dimension being the primary dimension and the first dimension being the child dimension.

4. The system of claim 3 wherein:
the graphical representation comprises a chart that represent the data values; and
in response to receiving user selection of a portion of an area of the chart, presenting detailed information of the selected portion.

5. The system of claim 4 further comprising presenting an updated graphical representation to enlarge a data element and its related data elements of lower level dimensions and the corresponding data values in response to receiving a selection of the data element.

6. The system of claim 4 further comprising updating the graphical representation to return to an overview visualization of the data set in accordance with the selected dimensions based on the second drill down order in response to receiving a user selection of a blank area on the display.

7. The system of claim 1 wherein:
a dimension is associated with an icon which is selectable to remove the dimension and its corresponding elements from the visualization; and
the processor device is configured to present an updated graphical representation of the data set without the removed dimension upon user selection of the icon.

8. The system of claim 1 wherein the user selection of the dimensions comprises adding one or more dimension to the dimensions that are displayed in a default overview visualization of the data set.

9. The system of claim 1 wherein the user selection of the dimensions comprises removing one or more dimension from the dimensions that are displayed in a default overview visualization of the data set.

10. A computer-implemented method for data visualization, comprising:
providing a data set comprising multi-dimensional data;
providing an edit control on a visualization that displays a list dimensions of the data set for user selection upon being activated;
in response to receiving user selection of one or more dimensions from the list of dimensions, presenting a graphical representation of the data set, the graphical representation comprises an overview visualization of the data set in accordance with the user selected dimensions; and
wherein the graphical representation comprises data elements and data values arranged in accordance with the selected dimensions in a first drill down order.

11. The computer-implemented method of claim 10 wherein the first drill down order is associated to positions of the dimensions on the graphical representation, wherein a drag and drop operation of a dimension to a different position changes the drill down order of the dimensions to a second drill down order, the graphical representation changes to display the data elements and the data values in accordance with the second drill down order.

12. The computer-implemented method of claim 11 wherein:
the first drill down order comprises a first dimension presented in a first position as a parent dimension and a second dimension presented in a second position as a child dimension of the parent dimension; and
the drag and drop operation comprises dragging and dropping the second dimension from the second position to the first position to change the drill down order to the second drill down order, resulting the second dimension being the primary dimension and the first dimension being the child dimension.

13. The computer-implemented method of claim 10 further comprising presenting an updated graphical representation to enlarge a data element and its related data elements of lower level dimensions and the corresponding data values in response to receiving a selection of the data element.

14. The computer-implemented method of claim 13 further comprising updating the graphical representation to return to an overview visualization of the data set in accordance with the selected dimensions based on the second drill down order in response to receiving a user selection of a blank area on the display.

15. The computer-implemented method of claim 10 wherein the user selection of the dimensions comprises adding one or more dimension to the dimensions that are displayed in a default overview visualization of the data set.

16. A non-transitory computer readable medium embodying a program of instructions executable by machine to perform steps comprising:
providing a data set comprising multi-dimensional data;
providing an edit control on a visualization that displays a list dimensions of the data set for user selection upon being activated;
in response to receiving user selection of one or more dimensions from the list of dimensions, presenting a graphical representation of the data set, the graphical representation comprises an overview visualization of the data set in accordance with the user selected dimensions; and
wherein the graphical representation comprises data elements and data values arranged in accordance with the selected dimensions in a first drill down order.

17. The non-transitory computer readable medium of claim 16 wherein the first drill down order is associated to positions of the dimensions on the graphical representation, wherein a drag and drop operation of a dimension to a different position changes the drill down order of the dimensions to a second drill down order, the graphical representation changes to display the data elements and the data values in accordance with the second drill down order.

18. The non-transitory computer readable medium of claim 17 wherein:
the first drill down order comprises a first dimension presented in a first position as a parent dimension and a second dimension presented in a second position as a child dimension of the parent dimension; and
the drag and drop operation comprises dragging and dropping the second dimension from the second position to the first position to change the drill down order to the second drill down order, resulting the second dimension being the primary dimension and the first dimension being the child dimension.

19. The non-transitory computer readable medium of claim 16 further comprising presenting an updated graphical representation to enlarge a data element and its related data elements of lower level dimensions and the corresponding data values in response to receiving a selection of the data element.

20. The non-transitory computer readable medium of claim 19 further comprising updating the graphical representation to return to an overview visualization of the data set in accordance with the selected dimensions based on the second drill down order in response to receiving a user selection of a blank area on the display.
